(19) United States
(12) Patent Application Publication
(10) Pub. No.: US 2026/0195853 A1
(43) Pub. Date: Jul. 9, 2026

(54) SUPERRESOLUTION OF PRACTICAL TWO-POINT PASSIVE SOURCES VIA PHYSICS-TRAINED MACHINE LEARNING

(71) Applicant: The Trustees of The Stevens Institute of Technology, Hoboken, NJ (US)

(72) Inventors: Xiaofeng QIAN, Short Hills, NJ (US); Abdelali SAJIA, Hoboken, NJ (US); Bilal BENZIMOUN, Worcester, MA (US)

(21) Appl. No.: 19/443,504

(22) Filed: Jan. 8, 2026

Related U.S. Application Data
(60) Provisional application No. 63/743,413, filed on Jan. 9, 2025.

(51) Int. Cl. G06T 3/4046; G06T 3/4053

(52) U.S. Cl. CPC G06T 3/4046; G06T 3/4053

(57) ABSTRACT

An advanced superresolution method to estimate sub-wavelength separations of practical two-point sources is presented herein. This method begins with a theoretical framework that accounts for realistic, unknown source properties such as partial coherence, brightness imbalance, and random phase. A physics-informed machine learning model is then trained to handle source-independent imperfections, including background noise, photon loss, and uncertainties in the center position and orientation of the two sources. Unlike many existing methods, the method presented herein does not require prior knowledge or control over source properties, making it highly applicable to astrophysical and biological imaging, as well as other precision measurement fields.

### CROSS REFERENCE TO RELATED APPLICATIONS

This application claims the benefit of U.S. Provisional Application No. 63/743,413, filed Jan. 9, 2025, the entire contents of which are incorporated herein by reference.

### FUNDING

This invention was made with government support under Grant Number PHY-2316878 awarded by the National Science Foundation and under Contract No. W15QKN24C0004 awarded by the U.S. Army Contracting Command. The government has certain rights in the invention.

### BACKGROUND

For more than a century, the Abbe-Rayleigh resolution criterion has been an inevitable obstacle, limiting the smallest resolvable separation of two spots in various imaging, sensing, and precision measurement tasks in the fields of physics, astronomy, chemistry, biology, etc. This limit (e.g., ~200 nm for visible light under conventional microscopic apparatus) is due to the fact that when two sources are getting closer, the blurred overlapping signal becomes harder to discriminate through direct intensity measurements.

Remarkably, various superresolution microscopy (SRM) methods for active sources (which can be partially controlled) such as stimulated emission depletion, structured illumination microscopy, photo-activated localization microscopy, stochastic optical reconstruction microscopy, have been employed to improve the optical resolution limit from ~200 nm to ~10 nm, which was recognized by the 2014 Nobel prize in chemistry. Unfortunately, these methods become invalid for more general cases where the sources are passive, i.e., not controllable or must not be disturbed. Recent advancements have shown that quantum spatial mode decomposition can achieve sub-wavelength superresolution for passive sources that need not to be controlled. However, such a method is shown to be valid only for idealized equal-intensity and incoherent point sources. Interestingly, a successful step toward releasing these restrictions have been developed theoretically to treat arbitrary unbalanced brightness (unbalanceness) and partial coherence. However, simultaneous treatment of generic source properties of partial coherence, unbalanceness, and random phase is still missing, not to mention various source-independent realistic issues such as background noise, photon loss, center-point and orientation uncertainties, etc.

On the other hand, machine learning methods have been applied to achieve super-resolved image shapes using spatial mode reconstruction. However, this approach remains limited to incoherent images with uniform brightness distributions. Furthermore, achieving higher resolution quality requires utilizing a greater number of spatial modes, particularly the less easily accessible higher-order modes, along with detailed amplitude and phase information for each mode. These requirements impose substantial demands on measurement precision and accuracy control, making the method more vulnerable to imperfections.

### SUMMARY

An improved approach that bypasses the need to estimate partial coherence, unbalanced brightness, and random phase is demonstrated and developed herein by introducing the relative contributions of any two spatial modes. This approach requires only a pair of spatial modes (or a few more pairs for optimization) without needing specific phase and amplitude information for each contributing mode, thus significantly reducing measurement complexity. This method is further integrated with a Convolutional Neural Network (CNN) and show that it can achieve over 90% fidelity in superresolution of two-point sources separated by distances up to 16 times smaller than the conventional resolution limit, using a standard desktop graphics processing unit (GPU). This approach also effectively manages practical challenges, including background noise, photon loss, center point uncertainty, and arbitrary two-source orientations. Our realistic experimental data reaches over 80% fidelity for the same small separations (up to 16 times smaller than the conventional resolution limit). These results represent a substantial advancement in super-resolution for realistic passive sources, applicable in fields like biological and astrophysical imaging.

The process described herein is the first of its kind that is capable to deal with realistic challenges of two-source superresolution altogether. The practical challenges include a) partial coherence, b) unbalanced brightness, c) unknown noise, d) photon detection inefficiency, e) center point uncertainty, and f) arbitrary two-source orientation. Existing superresolution techniques dealing with passive sources is not capable to deal with even one of these practical challenges with high fidelity. The process can be used to enhance the resolution capability of existing imaging products (for astronomy, biology, and other precision measurements) for fine resolution. The process can further be used to build a real-time feedback-controlled superresolution imaging system to optimize the fine resolution capability.

### BRIEF DESCRIPTION OF THE DRAWINGS

While the specification concludes with claims, which particularly point out and distinctly claim the subject matter described herein, it is believed the subject matter will be better understood from the following description of certain examples taken in conjunction with the accompanying drawings, in which like reference numerals identify the same elements. The figures depict one or more implementations of the inventive devices, by way of example only, not by way of limitation.

FIG. 1 is a schematic illustration of the CNN procedure to estimate two-source separation.

FIG. 2 includes example training images.

FIGS. 3(a), 3(b), 3(c), and 3(d) include plots of fidelity of ML estimated separation s_{E} compared with actual real separation s_{R} with respect to separation s for 200,000 training images with 38×38 pixels. FIG. 3(a) illustrates the case when only the separation s is unknown and all other parameters are known, where γ=0, u=1, φ=0. FIG. 3(b) illustrates the case when s and u are unknown and γ=0, φ=0. FIG. 3(c) shows the case when s and γ are unknown and u=1, φ=0. FIG. 3(d) illustrates the case when all parameters s, γ, u, φ are unknown.

FIG. 4 includes charts showing effects of background luminosity noise and photon loss on the separation fidelity with respect to the number of infected pixels. The top panel is a plot of background luminosity noise. The bottom panel is a plot of photon loss. Both cases employ 30,000 training images with 27×27 pixels at a fixed separation of s=σ/4.

FIG. 5 is a plot showing effect of phase noise on separation fidelity for 100 images with different random phases. Random phase is not having a big effect on the fluctuation of the fidelity. This is analyzed for 30,000 training images with 27×27 pixels at a fixed separation of s=σ/4.

FIGS. 6(a) and 6(b) include plots showing fidelity with respect to the two-source separation influenced by number of training images and pixel numbers of each image. The plot in FIG. 6(a) illustrates the result of 200,000 20×20 pixelated training images, and the plot in FIG. 6(b) the result of 50,000 10×10 pixelated training images. To ensure a fair comparison, we consider situations with a consistent number of training images per pixel, i.e., 500 training images per pixel.

FIG. 7 is a plot of fidelity of ML estimated separation s_{E} for 200,000 training images with 38×38 pixels compared with experimental separation s_{R}. Experimental testing images are generated with partial coherence γ=0.8 and unbalanceness u=0.75 when other parameters are kept unknown with realistic imperfection of background noise and photon loss.

### DETAILED DESCRIPTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description enables one skilled in the art to make and use the invention, and describes several embodiments, adaptations, variations, alternatives and uses of the invention, including what is presently believed to be the best mode of carrying out the invention.

Alternative apparatus and system features and alternative method steps are presented in example embodiments herein. Each given example embodiment presented herein can be modified to include a feature and/or method step presented with a different example embodiment herein where such feature and/or step is compatible with the given example as understood by a person skilled in the pertinent art as well as where explicitly stated herein. Such modifications and variations are intended to be included within the scope of the claims.

Methods presented herein can be carried out computationally. For instance, non-transitory computer-readable medium can include instructions thereon that are executable by one or more processors to cause the one or more processors to cause a computational system or device to execute the instructions to perform steps of the methods presented herein.

An advanced superresolution method to estimate sub-wavelength separations of practical passive two-point sources is presented herein. This method begins with a theoretical framework that accounts for realistic, unknown source properties such as partial coherence, unbalanced brightness, and random phase. A physics-informed machine learning model is then trained to handle source-independent imperfections, including background noise, photon loss, and uncertainties in the center position and orientation of the two sources. Using a standard commercial desktop, in examples presented herein, the method achieves over 90% fidelity for separations up to 16 times smaller than the conventional resolution limit for program generated testing images. In common optical microscopy setups, this corresponds to a resolution of 11.2 nm, comparable to the most advanced superresolution microscopy technologies available. Unlike many existing methods, the method presented herein does not require prior knowledge or control over source properties, making it highly applicable to astrophysical and biological imaging, as well as other precision measurement fields.

### Methods—A. Superresolution Theory Bypassing Multi-Parameter Estimation

The most general case is treated in which a two-point source with two spatial components wherein the spatial domain is described by a an arbitrary mixed state, i.e., ρ=p₊|h₊ [symbol] [symbol] h₊|+p₋|h₋ [symbol] [symbol] h₋|+γ|h₊ [symbol] [symbol] h₋+γ*|h₋ [symbol] [symbol] h₊|. Here |h_{±} [symbol] are the wavefunctions of the two corresponding point sources with [symbol] x|h_{±} [symbol] =h_{±}(x)=h(x±s/2) representing the spatial dependence, p_{±} are corresponding probabilities, γ=|γ|e^{iφ} with |γ|≤1 due to Cauchy-Schwarz inequality. The spatial function h(x) is the Gaussian-shaped point spread function given as

$${h}^{2} ( x ) = \frac{1}{\sqrt{2 {πσ}^{2}}} exp [ - \frac{{x}^{2}}{2 {σ}^{2}} ]$$

with σ representing the width of the Gaussian profile. Note that although [symbol] h₊|h₋ [symbol] ≠0, the state p still represents the most general two-state mixture. Here realistic imperfections of the two sources are reflected by u=p₊/p₋ representing arbitrary unbalanceness, φ being arbitrary relative phase, and |γ| characterizing arbitrary partial coherence.

Such a mixed state can be re-expressed with an orthogonal basis, e.g., {|h₊ [symbol] |h̅₊̅ [symbol] }, where |h₋ [symbol] =α|h₊ [symbol] +β|h₊ [symbol] into a 2×2 matrix. One may purify the matrix with an auxiliary party and basis change to achieve

$$\vert Ψ 〉 = a \vert {h}_{+} 〉 \vert {ϕ}_{1} 〉 + b {e}^{i φ} \vert {h}_{-} 〉 \vert {ϕ}_{2} 〉 , \qquad ( 1 )$$

where a, b are normalized coefficients with a generic ratio u=|b/a|²=p₊/p₋ representing arbitrary unbalanceness, φ is an arbitrary relative phase. Here |φ₁ [symbol] and |φ₂ [symbol] are two normalized functions of the auxiliary party with a generic statistical overlap [symbol] φ₁|φ₂ [symbol] =γ, representing arbitrary partial coherence.

In principle, the spatial domain of the above two-point source signal can always be decomposed into the superposition of infinite spatial basis modes, e.g., the Hermite-Gaussian (HG) modes {|Φ_{q} [symbol] }which is given as

$${Φ}_{q} ( x ) = 〈 x \vert {Φ}_{q} 〉 = {( \frac{1}{2 π {σ}^{2}} )}^{1 / 4} \frac{1}{\sqrt{{2}^{q} q !}} {H}_{q} ( \frac{x}{\sqrt{2} σ} ) exp [ \frac{- {x}^{2}}{4 {σ}^{2}} ] , \qquad ( 2 )$$

where q=0, 1, 2, 3, . . . , ∞ represents all non-negative integers.

Then the probability of detecting the photon (or the intensity for classical light field) in the q^{th} mode can be computed as

$${p}_{q} = 〈 Ψ \vert {Φ}_{q} 〉 ( {Φ}_{q} \vert Ψ 〉 = {η}_{q} ( s ) [ 1 + 2 a b Re ( {e}^{i φ} γ ) ] , \qquad ( 3 )$$

$$where$$

$${η}_{q} ( s ) = Exp [ \frac{- {s}^{2}}{16 {σ}^{2}} ] {( \frac{{s}^{2}}{16 {σ}^{2}} )}^{q} \frac{1}{q !} \qquad ( 4 )$$

depends only on the separation s. In previous studies, the amplitude coefficient C_{q} is often used to describe the projection properties with C_{q}=Tr_{φ}[ [symbol] Φ_{q}|Ψ [symbol] ], where Tr_{φ} means tracing off the φ degrees of freedom. This coefficient corresponds to the probability description directly through p_{q}=|C_{q}|².

It is important to note that the probability or coefficient (3) contains multiple realistic source parameters, i.e., separation s, two-source partial coherence γ, unbalanceness u=(b/a)² (due to normalization only one of a and b or their ratio will be enough to represent unbalanceness), and relative phase φ. Therefore, in this general two-source scenario, there are at least four unknown parameters need to be estimated, which will significantly reduce Fisher information, making the measurements unreliable. This explains exactly why the previous mode demultiplexing method fails for unbalanced and partially coherent sources, where the required multi-parameter estimation.

Remarkably, the above-mentioned multi-parameter estimation difficulty can be avoided. It is noted that when taking the ratio of any two mode probability contributions, e.g., q, q₀, it contains only the separation s parameter, i.e.,

$${r}_{q} = \frac{{p}_{q}}{{p}_{{q}_{0}}} = \frac{{η}_{q}}{{η}_{{q}_{0}}} \qquad ( 5 )$$

is completely independent of the additional practical parameters γ, u, φ, making them irrelevant in the measurement estimation. The Fisher information of measuring this ratio can be computed to be

$$J = {e}^{( {s}^{2} / 16 {σ}^{2} )} \frac{N}{4 {σ}^{2}} \geq \frac{N}{4 {σ}^{2}} , \qquad ( 6 )$$

where we have taken q₀=0. Remarkably, the Fisher information j is always greater than a finite constant N/4σ² for all separation s even when it approaches zero, indicating the measurement of r_{q} a highly credible measurement protocol. Thus, measuring the probability ratio of two contributing modes only requires estimating the key unknown parameter, i.e., the separation s, which can be obtained straightforwardly as

$$s = 4 {σ ( \frac{{r}_{q} q !}{{q}_{0} !} )}^{1 / 2 ( q - {q}_{0} )} . \qquad ( 7 )$$

It is important to remark that here q is an arbitrary mode number, which allows maximum flexibility in the actual implementation of the separation-estimation measurements. For example, if one take q=1 and q₀=0, the separation can be simply achieved as s=4σ\sqrt{r₁}.

### Methods—B. Physics-Informed Machine Learning

The theoretical result in the above section indicates how to obtain the separation s with minimum estimation effort, the next task is to measure the ratio r. It is natural to carry out the measurement of two individual coefficients, e.g., with existing mode demultipexing techniques in superresolution approaches, and then take the ratio. However, it is still unclear and untested about the robustness of these measurement approaches against the practical source-independent issues of background noise, photon detection inefficiency, center point uncertainty, and arbitrary two-source orientations. Therefore, here we take an alternative approach, i.e., to incorporate with a particularly physics-informed machine learning procedure that is facilitated by our theory above (6). It turns out that our approach is very robust against all these practical issues simultaneously. We support the results with experimental confirmation.

FIG. 1 is a schematic illustration of the CNN procedure to estimate two-source separation.

To carry out the machine learning assisted superresolution, there are two essential elements, i.e., (1) to develop a physics-trained program obtaining the two-mode ratio r=p_{q}/p_{q′}, and (2) to incorporate source-independent noise and imperfection effects to enhance robustness.

To accomplish the first goal, we employ convolutional neural networks (CNN) as a tool for image recognition based on the ratio of multiple pairs of spatial mode basis, where the target two-source separation is trained through the analytical relation (6). From the fact that two closely separated point sources are mostly concentrated in lower order HG spatial modes, we take the first six modes to construct probability ratios (5) in the training process. This is realized through creating six neurons (employing ReLU activation function) in the last dense layer that connects to the flattened one-dimensional vector generated from a series of 2D-convolutional layers. These six neurons utilize the sigmoid function to produce output values within the range of 0 to 1 to create mutual contribution ratios among the six modes.

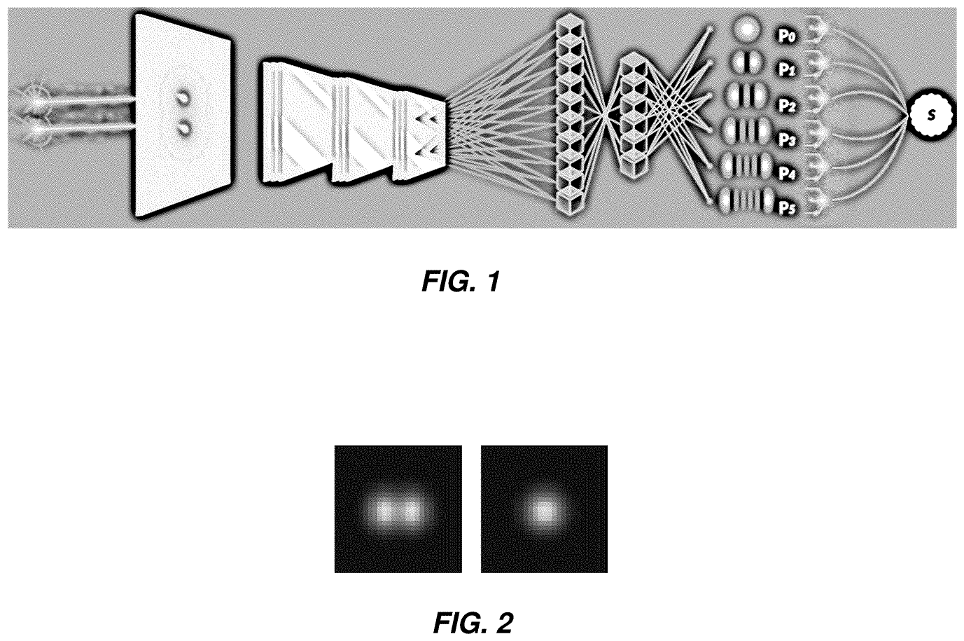

FIG. 2 includes example training images.

The CNN model gradually increases the number of filters through its convolutional layers and concludes with a multi-class classification output layer, making it suitable for identifying complex patterns or classes within images while maintaining sensitivity to intricate image features. We carry out the downsizing using Average-pooling layers instead of Max-pooling (which is commonly used), in order to keep the profile information while downsizing the image by selecting maximum pixel values in the pooling region. To ensure high accuracy we employed seven epochs during training.

To fulfill the second goal, we produce a dataset of 200,000 38×38 pixelated training images with realistic random parameters a, b, γ, φ, as well as with arbitrary center-point and orientation uncertainties. The two-source separation is also randomly generated within the range of s<σ beyond the traditional resolution limit a. To assure the performance of the trained CNN, we use 100 simulated testing samples that are not part of the training dataset and compare the ML predictions to the known coefficients for those testing images. To account the photon luminosity noise, we generate images with random extra brightness (more photons due to noise signal) for a random 10% of the total pixels. Similarly, to include possible photon loss or detection inefficiency, we generate images with random extra dimness (less photons due to loss) for a random 10% of the total pixels.

### Results

With the physics-informed training, the CNN program is able to extract the ratio of coefficients for Hermit Gaussian basis modes from the testing samples with an accuracy of 99%. This means that the classification procedure of the program is at a very high quality. However, this accuracy can't be used to tell the quality of the superresolution estimation. Therefore, we define a fidelity measure to quantify the degree to which the estimated separation s_{E} is close to the actual real separation s_{R} of the testing images, i.e.,

$$F = 1 - \frac{\vert {s}_{E} - {s}_{R} \vert}{{s}_{E} + {s}_{R}} . \qquad ( 8 )$$

When s_{E}=s_{R}, F=1, corresponding to the perfect accuracy case. When F=0, i.e., s_{E}<<s_{R} or s_{E}>>s_{R}, it indicates the worst accuracy case with a maximum possible error.

To test the physics-trained machine learning program, we experimentally generate various testing images for examination in three major categories considerations. The results are provided in the following corresponding subsections.

### Results—Robustness Against Unknown Source Parameters

The first category of results is referred to the performance of our ML program under multiple unknown parameters of the two-point source. We analyze the fidelity F with respect to the two-source separation for arbitrary unknown partial coherence γ, unbalaceness u, and random phase φ. These are considered for images with a fixed number of pixels (38×38) and a fixed number (200,000) of training images.

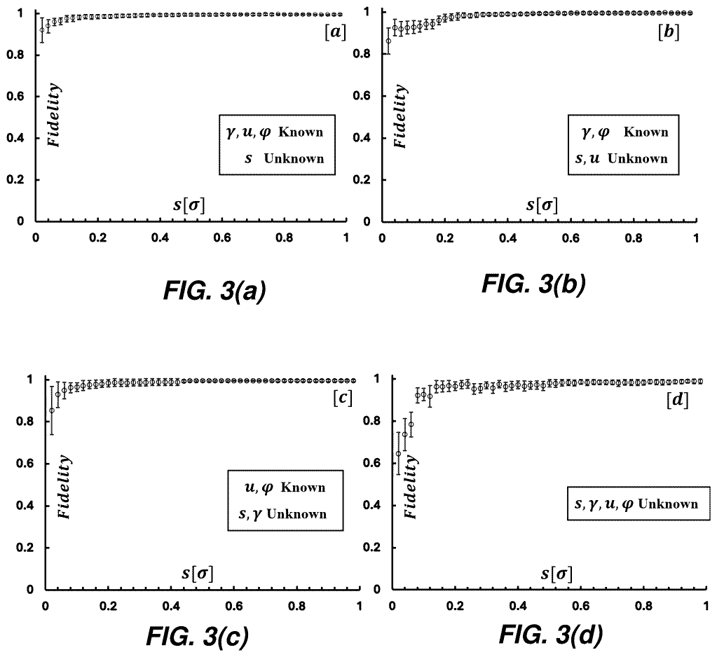

FIGS. 3(a) through 3(d) illustrate the obtained results. It is a plot of fidelity of ML estimated separation for 200,000 training images with 38×38 pixels. FIG. 3(a) illustrates the case when only the separation s is unknown and all other parameters are known, where γ=0, u=1, φ=0. FIG. 3(b) illustrates the case when s and u are unknown and γ=0, φ=0. FIG. 3(c) shows the case when s and γ are unknown and u=1, φ=0. FIG. 3(d) illustrates the case when all parameters s, γ, u, φ are unknown. Apparently, the CNN program is capable to achieve very high fidelity F>0.9 for the region σ/16<s<σ for various cases as shown in plots of FIGS. 3(a), 3(b), and 3(c), well beyond the traditional Abbe-Rayleigh resolution limit 6.

Prior knowledge of one or more of the realistic parameters (γ, u, and φ) will reduce the computation complexity of the CNN program, thus reaching a higher fidelity. As an illustration, we repeat the same ML estimation process by fixing the quantities (γ, u, and φ). The obtained fidelity has higher values of F>0.95 in the same region (σ/16<s<σ/2), see illustration in FIG. 3(a)

So far, we have supposed that the centroid of the two incident beams is known. However, in reality the two-source center point can be hard to determine. To account this feature, we train the CNN program with more realistic images that has a random variation of the centroid for 3 pixels either to the left or right of the center of the 38×38 pixelate image (i.e., with a 7.8% of uncertainty). Such a specially trained program remains to be robust against the centroid uncertainty with the estimation fidelity above 0.85 for σ/16<s<σ, shown by FIG. 3(d).

These results are all tested and contained in the experimental section.

### Results—Robustness Against Source-Independent Imperfections

In addition to the realistic source-dependent parameters, partial coherence, unbalanceness, and random relative phase, there are many source-independent practical imperfections, e.g., background luminosity noise, photon loss or detection inefficiency, background phase noise through propagation, two-source orientation uncertainties, etc. These imperfections are either introduced by the environment or by device limitations. Separation estimation of our ML model under these realistic effects is explored.

To show the only effects of these source-independent imperfections, the source parameters s, u, γ, φ are kept known. For noise effect, we set the luminosity of each pixel of all samples in the range [0,255]. The background photon noise is introduced by augmenting pixel intensities with an additional random amount ranging between 1 and 26. This augmentation is up to 10% of the original signal intensity, which represents most common scenarios of average noise level.

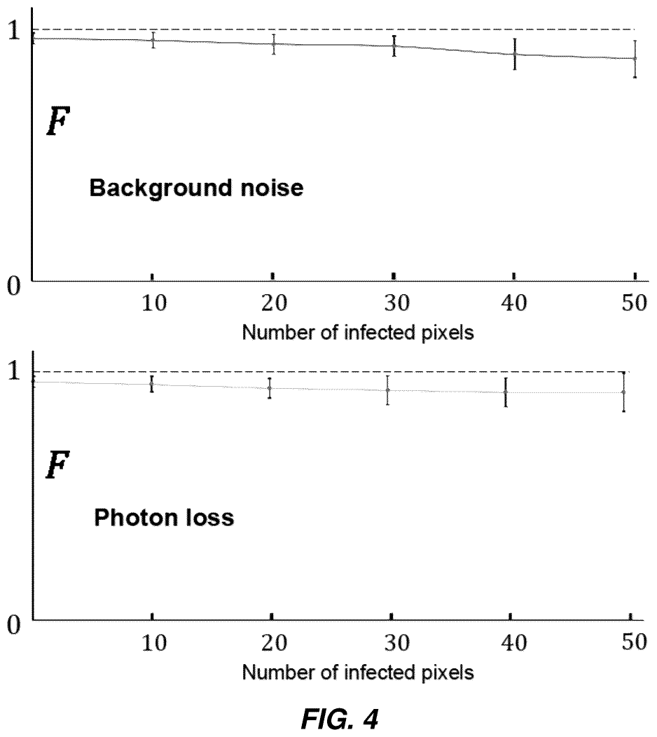

FIG. 4 shows the fidelity behavior after including different numbers of noisy pixels at the fixed separation of σ/4. It is noted that our model is robust against such noise with only slight decreasing of the fidelity as the number of infected pixels increases.

On the other hand, instead of additional photon noise, there can also be photon loss through propagation or due to inefficiency of detection. We introduce photon loss by diminishing the intensity of random pixels in the original image by a random amount between 1 and 26, representing a 10% loss. FIG. 4 shows the fidelity behavior after including different numbers of photon-loss pixels at fixed separation σ/4. One notes that our model is again robust against photon loss with only slight decreasing of the fidelity as the number of infected pixels increases.

Phase noise is another crucial factor in realistic scenarios, especially when the light source or its pathway is exposed to mechanical disturbances or vibrations. These disruptions can severely inhibit, if not make impossible, applications requiring precision measurements. Here we introduce an additional random phase, originating from various disturbances encountered during the propagation of the two beams, and examine its impact on the fidelity of separation estimation.

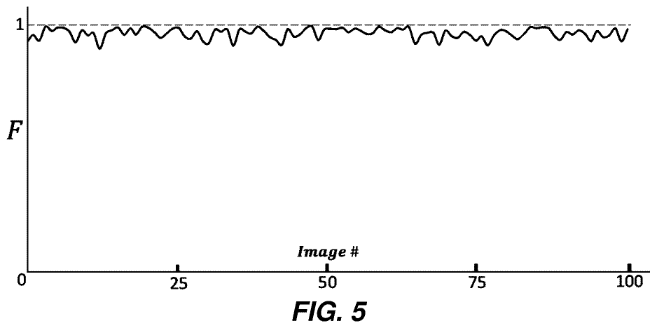

FIG. 5 illustrates the effect of phase noise for 100 testing images each contains arbitrary random phase. One notes that fidelity is over 0.95 for all of these cases. This means that our CNN model is resilient against the presence of any phase noise.

### Results—Effects of Training Sample Properties

In addition to various realistic considerations of the source and noise imperfections, the performance of our separation estimation CNN model is affected by properties of the training image samples. Here analyze the effects of two primary factors that influence the separation estimation fidelity: (1) the number of training images, and (2) the number of pixels for each image. We examine two different pixel-number images, i.e., 10×10 and 20×20.

To ensure a fair comparison, we consider situations with a consistent number of training images per pixel. That is, for 10×10 and 20×20 pixels of images, we use 50,000, and 200,000, training images respectively. In all cases, there is approximately training 500 images per pixel.

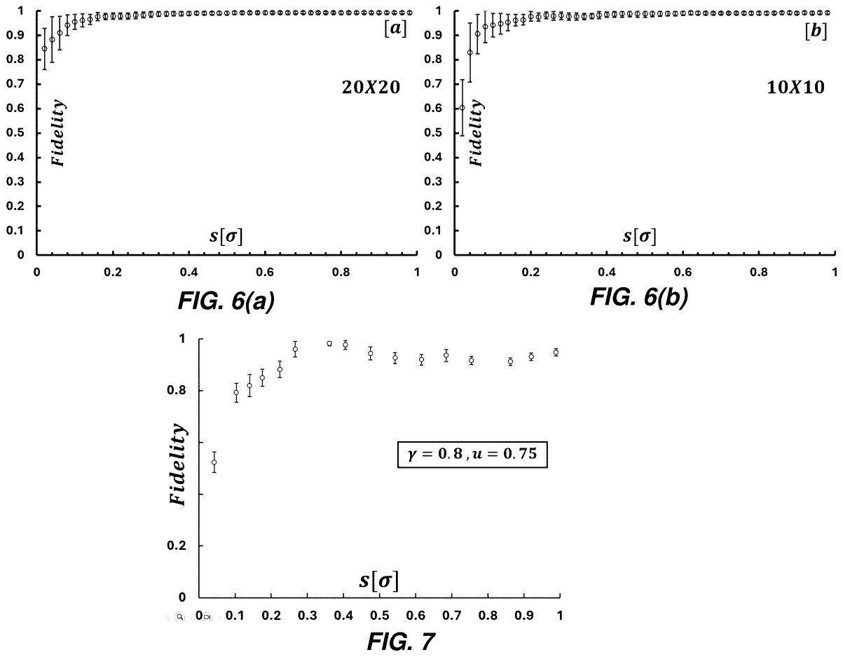

FIGS. 6(a) and 6(b) illustrate the separation estimation fidelity for the two pixel-image configurations. The source unknown parameters s, u, γ, φ are kept fixed. It is noted that the better performed case is 200,000 20×20 training images, of which one can obtain high fidelity F>0.9 for separations

$$s ≳ \frac{σ}{20} .$$

The case 50,000 10×10 training images, although less quality still maintains very high fidelity, exceeding 0.85 when separation

$$s ≳ \frac{σ}{20} .$$

Apparently, more training images will enhance the separation estimation fidelity even when keeping the number of images per pixel a constant.

### Results—Realistic Experimental Testing Images

To confirm the theoretical results, we generate experimental images that simultaneously contain all realistic imperfections: partial coherence, unbalanceness, random relative phase, background noise, photon loss, phase noise, center-point and orientation uncertainties, to test the quality of the physics-trained superresolution ML model.

FIG. 7 illustrates the experimental fidelity behavior with respect to separation s for partially coherent (γ=0.8) and unbalanced (u=0.75) two-point sources. Despite all the practical imperfections, the presented physics-informed superresolution ML program is still capable to reach fidelity F>0.8 for separations larger

$$s ≳ \frac{σ}{16} .$$

### CONCLUSION

In conclusion, the superresolution of two realistic point sources is demonstrated by combining physics theory, machine learning algorithms, and experimental validation. Theoretically, it is identified that the ratio of spatial mode contributions in the two-source signal is independent of the key unknown parameters for realistic two-point sources: partial coherence γ, unbalanceness u, and random relative phase φ. This ratio allows one to bypass the limitations associated with multi-parameter estimation.

A Convolutional Neural Network (CNN) model is trained to accommodate two main categories of realistic considerations: (1) unknown source parameters γ, u, and φ encompassed by theory, and (2) source-independent factors including background photon luminosity noise, photon loss noise, as well as uncertainties in the two-source centroid and orientation.

The machine learning-augmented approach presented herein demonstrates exceptional performance, achieving an estimation fidelity over 0.9 in principle in predicting source separations as small as 1/16 of the traditional Rayleigh limit, defined by the width a of a point source image. In common microscopic setups with visible light (e.g., green light with 500 nm wavelength), this width a corresponds σ≈λ/2.8. Thus, our resolution capability reaches approximately, 180 nm/16≈11.2 nm, rivaling state-of-the-art biological imaging, with fidelity remaining high at 0.9 in principle. For our experiment, we achieve fidelity over 0.8.

This result is achieved using only a standard workstation equipped with a GPU and CPU, highlighting the efficiency and practicality of our approach. Our method offers promising potential for fine-resolution applications across passive sources in astrophysics, biological imaging, and other precision measurement fields.

Having shown and described exemplary embodiments of the subject matter contained herein, further adaptations of the methods and systems described herein may be accomplished by appropriate modifications without departing from the scope of the claims. In addition, where methods and steps described above indicate certain events occurring in certain order, it is intended that certain steps do not have to be performed in the order described but, in any order, as long as the steps allow the embodiments to function for their intended purposes. Therefore, to the extent there are variations of the invention, which are within the spirit of the disclosure or equivalent to the inventions found in the claims, it is the intent that this patent will cover those variations as well. Some such modifications should be apparent to those skilled in the art. For instance, the examples, embodiments, geometrics, materials, dimensions, ratios, steps, and the like discussed above are illustrative. Accordingly, the claims should not be limited to the specific details of structure and operation set forth in the written description and drawings.

Clause 1: A non-transitory computer-readable medium with instruction thereon, that when executed by one or more processors, cause the one or more processors to: estimate separation of two spatial components within a two-point source; and obtain a two-mode ratio based at least in part on the estimated separation and using a machine-learning model trained on based in part on an analytical relation for separation.

Clause 2: The non-transitory computer-readable medium of clause 1, wherein the machine-learning model is further trained on datasets with realistic random parameters a, b, γ, φ, arbitrary center-point and orientation uncertainties, and a range of separation.

Clause 3: The non-transitory computer-readable medium of clause 1, wherein the machine-learning model is further trained to account for source-independent noise and imperfection effects.

Clause 4: The non-transitory computer-readable medium of clause 1, wherein the machine-learning model is trained to account for photon luminosity noise with images with random extra brightness.

Clause 5: The non-transitory computer-readable medium of clause 4, wherein the images with random extra brightness include more photons due to noise signal for a portion of the total pixels.

Clause 6: The non-transitory computer-readable medium of clause 1, wherein the machine-learning model is trained to account for possible photon loss or detection inefficiency with images having random extra dimness.

Clause 7: The non-transitory computer-readable medium of clause 6, wherein the images having random extra dimness have fewer photons due to loss for a portion of the total pixels.

Clause 8: The non-transitory computer-readable medium of clause 1, wherein the instructions are further configured to cause the one or more processors to determine unknown source parameters γ, u, and φ.

Clause 9: The non-transitory computer-readable medium of clause 1, wherein the machine-learning model comprises a convolutional neural network.

Clause 10: The non-transitory computer-readable medium of clause 9, wherein the convolutional neural network includes a plurality of convolutional layers that gradually increase in number of filters.

Clause 11: The non-transitory computer-readable medium of clause 9, wherein the convolutional neural network includes average-pooling layers for downsizing.

Clause 12: The non-transitory computer-readable medium of clause 1, wherein the two-mode ratio is based on a ratio of probability contributions of two spatial mode basis modes.

Clause 13: The non-transitory computer-readable medium of clause 12, wherein the spatial mode basis modes comprise Hermite-Gaussian modes.

Clause 14: The non-transitory computer-readable medium of clause 1, wherein the estimated separation achieves a fidelity greater than 0.9 for separations up to 16 times smaller than a conventional resolution limit.

Clause 15: A method for superresolution of two-point passive sources, the method comprising: receiving an image of a two-point source having two spatial components; processing the image using a physics-informed machine-learning model to estimate a separation between the two spatial components; and outputting the estimated separation, wherein the physics-informed machine-learning model is trained based at least in part on an analytical relation that relates a ratio of spatial mode probability contributions to the separation.

Clause 16: The method of clause 15, wherein the physics-informed machine-learning model comprises a convolutional neural network trained on training images having realistic random parameters including partial coherence, unbalanced brightness, and random phase.

Clause 17: The method of clause 15, wherein the ratio of spatial mode probability contributions is independent of: partial coherence; unbalanced brightness; and random phase of the two-point source.

Clause 18: The method of clause 15, wherein the physics-informed machine-learning model is further trained to account for: background luminosity noise; and photon loss.

Clause 19: The method of clause 15, wherein the physics-informed machine-learning model is further trained to account for: center-point uncertainty; and orientation uncertainty of the two-point source.

Clause 20: The method of clause 15, wherein the estimated separation is up to 16 times smaller than a conventional Abbe-Rayleigh resolution limit.

What is claimed is:

1. A non-transitory computer-readable medium with instruction thereon, that when executed by one or more processors, cause the one or more processors to:
estimate separation of two spatial components within a two-point source;
obtain a two-mode ratio based at least in part on the estimated separation and using a machine-learning model trained on based in part on an analytical relation for separation.

2. The non-transitory computer-readable medium of claim 1, wherein the machine-learning model is further trained on datasets with realistic random parameters a, b, γ, φ, arbitrary center-point and orientation uncertainties, and a range of separation.

3. The non-transitory computer-readable medium of claim 1, wherein the machine-learning model is further trained to account for source-independent noise and imperfection effects.

4. The non-transitory computer-readable medium of claim 1, wherein the machine-learning model is trained to account for photon luminosity noise with images with random extra brightness.

5. The non-transitory computer-readable medium of claim 4, wherein the images with random extra brightness include more photons due to noise signal for a portion of the total pixels.

6. The non-transitory computer-readable medium of claim 1, wherein the machine-learning model is trained to account for possible photon loss or detection inefficiency with images having random extra dimness.

7. The non-transitory computer-readable medium of claim 6, wherein the images having random extra dimness have fewer photons due to loss for a portion of the total pixels.

8. The non-transitory computer-readable medium of claim 1, wherein the instructions are further configured to cause the one or more processors to determine unknown source parameters γ, u, and φ.

9. The non-transitory computer-readable medium of claim 1, wherein the machine-learning model comprises a convolutional neural network.

10. The non-transitory computer-readable medium of claim 9, wherein the convolutional neural network includes a plurality of convolutional layers that gradually increase in number of filters.

11. The non-transitory computer-readable medium of claim 9, wherein the convolutional neural network includes average-pooling layers for downsizing.

12. The non-transitory computer-readable medium of claim 1, wherein the two-mode ratio is based on a ratio of probability contributions of two spatial mode basis modes.

13. The non-transitory computer-readable medium of claim 12, wherein the spatial mode basis modes comprise Hermite-Gaussian modes.

14. The non-transitory computer-readable medium of claim 1, wherein the estimated separation achieves a fidelity greater than 0.9 for separations up to 16 times smaller than a conventional resolution limit.

15. A method for superresolution of two-point passive sources, the method comprising:
receiving an image of a two-point source having two spatial components;
processing the image using a physics-informed machine-learning model to estimate a separation between the two spatial components; and
outputting the estimated separation,
wherein the physics-informed machine-learning model is trained based at least in part on an analytical relation that relates a ratio of spatial mode probability contributions to the separation.

16. The method of claim 15, wherein the physics-informed machine-learning model comprises a convolutional neural network trained on training images having realistic random parameters including partial coherence, unbalanced brightness, and random phase.

17. The method of claim 15, wherein the ratio of spatial mode probability contributions is independent of partial coherence, unbalanced brightness, and random phase of the two-point source.

18. The method of claim 15, wherein the physics-informed machine-learning model is further trained to account for background luminosity noise and photon loss.

19. The method of claim 15, wherein the physics-informed machine-learning model is further trained to account for center-point uncertainty and orientation uncertainty of the two-point source.

20. The method of claim 15, wherein the estimated separation is up to 16 times smaller than a conventional Abbe-Rayleigh resolution limit.
